(19) United States
(12) Patent Application Publication
(10) Pub. No.: US 2022/0140959 A1
(43) Pub. Date: May 5, 2022

(54) CLI MEASUREMENT REPORTING IN TELECOMMUNICATION SYSTEMS

(71) Applicant: Nokia Technologies OY, Espoo (FI)

(72) Inventors: Klaus Ingemann PEDERSEN, Aalborg (DK); Benny VEJLGAARD, Gistrup (DK); Nuno Manuel KIILERICH PRATAS, Gistrup (DK); Oana-Elena BARBU, Aalborg (DK); Johannes HARREBEK, Aalborg (DK)

(73) Assignee: Nokia Technologies OY, Espoo (FI)

(21) Appl. No.: 17/431,030

(22) PCT Filed: Feb. 12, 2020
(86) PCT No.: PCT/EP2020/053538

§ 371 Date: Aug. 13, 2021

Related U.S. Application Data
(60) Provisional application No. 62/805,475, filed on Feb. 14, 2019.

(51) Int. Cl. H04L 5/00; H04W 72/08; H04L 25/03

(52) U.S. Cl. CPC H04L 5/006; H04L 5/0048; H04L 25/03261; H04W 72/082; H04L 5/0053

(57) ABSTRACT

According to a first example embodiment, a method may include transmitting, by a network entity, at least one radio resource control (RRC)-based cross link interference (CLI) measurement framework object configured for at least one user equipment (UE) CLI measurement. The method may further include receiving, by the network entity, at least one reporting message. The method may further include resolving at least one inter-UE CLI problem on a semi-dynamic time scale based upon reporting rates associated with RRC measurements and/or pre-defined behavior.

### CROSS REFERENCE TO RELATED APPLICATION

This application claims the benefit of U.S. Provisional Application No. 62/805,475, filed Feb. 14, 2019. The entire content of the above-referenced application is hereby incorporated by reference.

### BACKGROUND

### Field

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for improved management of cross-link interference.

### Description of the Related Art

3rd Generation Partnership Project (3GPP) technology includes user equipment (UE) cross link interference (CLI) measurements, which may enable a network entity to avoid scheduling users on resources which are detrimental due to CLI. In addition, such measurements may enable the network entity to coordinate scheduling between neighbor cells, evolved Node B (eNB) and next generation node B (gNB), and central units (CU) and distributed units (DU) to reduce any impact from detrimental CLI between UE. By default, scheduling decisions are performed by the part of the medium access control (MAC)-layer, and are conducted independently for each cell.

Downlink scheduling decisions by the network are based primarily on buffered/incoming traffic for the different UEs, corresponding quality of service (QoS) constraints, which may be expressed per data radio bearer (DRB), and UE air interface measurements, such as channels state information (CSI) measurement reports. However, there exists a need for standardization of filter and reporting of UE CLI measurements.

### SUMMARY

In accordance with some example embodiments, a method may include transmitting, by a network entity, at least one radio resource control (RRC)-based cross link interference (CLI) measurement framework object configured for at least one user equipment (UE) CLI measurement. The method may further include receiving, by the network entity, at least one reporting message.

In accordance with various example embodiments, an apparatus may include means for transmitting at least one radio resource control (RRC)-based cross link interference (CLI) measurement framework object configured for at least one user equipment (UE) CLI measurement. The apparatus may further include means for receiving at least one reporting message.

In accordance with certain example embodiments, an apparatus may include at least one processor and at least one memory including computer program code. The at least one memory and the computer program code can be configured to, with the at least one processor, cause the apparatus to at least transmit at least one radio resource control (RRC)-based cross link interference (CLI) measurement framework object configured for at least one user equipment (UE) CLI measurement. The at least one memory and the computer program code can be further configured to, with the at least one processor, cause the apparatus to at least receive at least one reporting message.

In accordance with some example embodiments, a non-transitory computer readable medium can be encoded with instructions that may, when executed in hardware, perform a method. The method may include transmitting at least one radio resource control (RRC)-based cross link interference (CLI) measurement framework object configured for at least one user equipment (UE) CLI measurement. The method may further include receiving at least one reporting message.

In accordance with various example embodiments, a computer program product may perform a method. The method may include transmitting at least one radio resource control (RRC)-based cross link interference (CLI) measurement framework object configured for at least one user equipment (UE) CLI measurement. The method may further include receiving at least one reporting message.

In accordance with certain example embodiments, an apparatus may include circuitry configured to transmit at least one radio resource control (RRC)-based cross link interference (CLI) measurement framework object configured for at least one user equipment (UE) CLI measurement. The circuitry may further be configured to receive at least one reporting message.

In accordance with some example embodiments, a method may include transmitting, by a network entity, at least one physical layer (PHY)/medium access control (MAC)-based configuration for at least one cross link interference (CLI) measurement. The method may further include receiving, by the network entity, at least one reporting message.

In accordance with various example embodiments, an apparatus may include means for transmitting at least one physical layer (PHY)/medium access control (MAC)-based configuration for at least one cross link interference (CLI) measurement. The apparatus may further include means for transmitting at least one physical layer (PHY)/medium access control (MAC)-based configuration for at least one cross link interference (CLI) measurement.

In accordance with certain example embodiments, an apparatus may include at least one processor and at least one memory including computer program code. The at least one memory and the computer program code can be configured to, with the at least one processor, cause the apparatus to at least transmit at least one physical layer (PHY)/medium access control (MAC)-based configuration for at least one cross link interference (CLI) measurement. The at least one memory and the computer program code can be further configured to, with the at least one processor, cause the apparatus to at least receive at least one reporting message.

In accordance with some example embodiments, a non-transitory computer readable medium can be encoded with instructions that may, when executed in hardware, perform a method. The method may include transmitting at least one physical layer (PHY)/medium access control (MAC)-based configuration for at least one cross link interference (CLI) measurement. The method may further include receiving at least one reporting message.

In accordance with various example embodiments, a computer program product may perform a method. The method may include transmitting at least one physical layer (PHY)/medium access control (MAC)-based configuration for at least one cross link interference (CLI) measurement. The method may further include receiving at least one reporting message.

In accordance with certain example embodiments, an apparatus may include circuitry configured to transmit at least one physical layer (PHY)/medium access control (MAC)-based configuration for at least one cross link interference (CLI) measurement. The circuitry may further be configured to receive at least one reporting message.

### BRIEF DESCRIPTION OF THE DRAWINGS

For proper understanding of this disclosure, reference should be made to the accompanying drawings, wherein:

FIG. 1 illustrates a high-level new radio user equipment radio resource management measurement model.

FIG. 2 illustrates configurable subband sizes.

FIG. 3 illustrates an example radio resource control (RRC)-based signaling diagram according to certain example embodiments.

FIG. 4 illustrates an example physical (PHY)/MAC-based signaling diagram according to certain example embodiments.

FIG. 5 illustrates an example of a RRC-based method according to certain example embodiments.

FIG. 6 illustrates an example of a PHY/MAC-based method according to certain example embodiments.

FIG. 7 illustrates an example of a system according to certain example embodiments.

### DETAILED DESCRIPTION

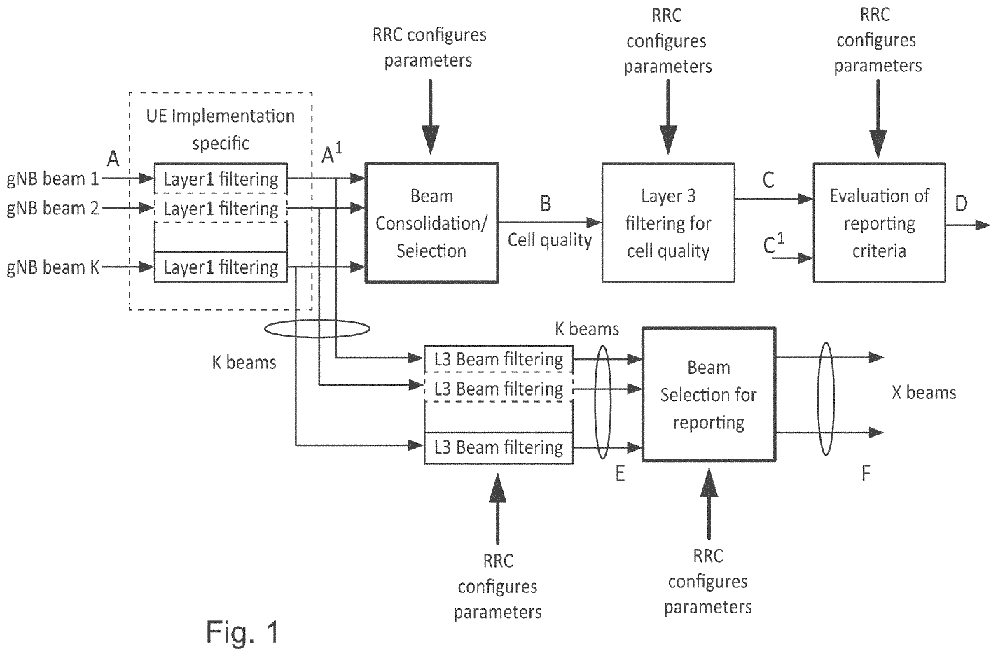

3GPP TS 38.300, section 9.2.4, summarizes the NR UE radio resource management (RRM) measurement model, as illustrated in FIG. 1. In particular, in RRC_CONNECTED mode, the UE measures at least one beam of a cell, and the measurements results, such as power values, are averaged to derive the cell quality. In doing so, the UE is configured to consider a subset of the detected beams. Filtering takes place at two different levels: at the physical layer to derive beam quality, and then at RRC level to derive cell quality from multiple beams, such as Layer-3 filtering. Similarly, cell quality from beam measurements is derived in the same way for the serving cells and for the non-serving cells. Measurement reports may contain the measurement results of the X best beams if the UE is configured to do so by the gNB.

Several components of the RRM measurement model may be modified and extended to also apply to UE CLI measurements. For example, the UE CLI measurements may both be subject to Layer-1 (L1) and Layer-3 (L3) filtering procedures, whereby the L3 filtering coefficients are configured by the network via higher layer RRC signaling. The defined RRM measurement framework relies on the network configuring at least one RRM measurement object for the UE, with each object defining the measurement and corresponding reporting criteria. The reporting criteria may include the A1, A2, . . . , A6 events, as well as others.

3GPP TS 38.213, Section 5.2, summarizes the NR UE CSI measurement framework. Here, each reporting setting CSI-ReportConfig is associated with a single downlink bandwidth part (indicated by higher layer parameter bwp-Id) given in the associated CSI-ResourceConfig for channel measurement. In addition, this contains at least one parameter for one CSI reporting band:codebook configuration including codebook subset restriction, time-domain behavior, frequency granularity for channel quality indicator (CQI) and pre-coding matrix indicator (PMI), measurement restriction configurations, and CSI-related quantities to be reported by the UE, such as the layer indicator (LI), L1-reference signal received power (RSRP), CSI-RS resource indicator (CRI), and SSB resource indicator (SSBRI).

With respect to higher layer signaling for one or more CSI Resource Settings for channel and interference measurement, CSI-IM resource for interference measurement is described in subclause 5.2.2.4, non-zero-power (NZP) channel state information-reference signal (CSI-RS) resource for interference measurement is described in subclause 5.2.2.3.1, and NZP CSI-RS resource for channel measurement is described in subclause 5.2.2.3.1. In addition, the reporting configuration for CSI can be aperiodic (using physical uplink shared channel (PUSCH)), periodic (using physical uplink control channel (PUCCH)) or semi-persistent (using PUCCH, and downlink control information (DCI) activated PUSCH). The CSI-RS resources can also be periodic, semi-persistent, or aperiodic.

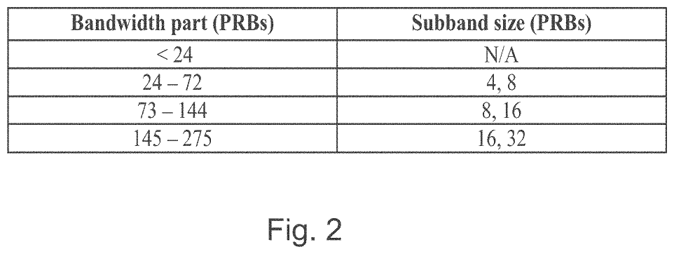

For CSI reporting, a UE can be configured via higher layer signaling with one out of two possible subband sizes, where a subband is defined as contiguous PRBs, and depends on the total number of PRBs in the bandwidth part according to the table disclosed in FIG. 2. It is noted that the reportFreqConfiguration contained in a CSI-ReportConfig indicates the frequency granularity of the CSI Report. In the context of UE CLI measurements/reporting, the UE measures the instantaneous received power from its serving cell (denoted as Layer-1 (L1)-RSRP), the UE can be configured to measure the experienced co-channel interference, and measurements can be wideband (carrier bandwidth or bandwidth party (BWP)) or frequency selective per subband.

As described above, UE CLI measurements come in the form of received signal strength indicator (RSSI) or sounding reference signal (SRS)-reference signal received power (RSRP) measurements, and are by default subject to L3 filtering. However, a lack of detail exists regarding L3 filtering, as well as reporting events and related means for UE CLI measurements. Furthermore, there are currently no techniques for how SRS-RSRP measurement reports and CLI-RSSI measurement reports can be configured together for a UE. A need exists in the art for improved filtering and reporting of UE CLI measurements.

Certain example embodiments described herein may have various benefits and/or advantages to overcome the disadvantages described above. Certain example embodiments described below may offer semi-dynamic information of the UE CLI experience to the network with limited complexity. For example, the network may use such information for per-cell scheduling decisions, as well as for semi-dynamic coordination between cells (or gNBs). For example, this information may enable alignment of radio frame configurations to reduce impact from UE-2-UE CLI. In addition, certain example embodiments offer faster and more accurate UE CLI information to the network at the same rate as UE CSI measurements, enabling the network to provide faster scheduling decisions. Such information offers fast adaptation and improved responsiveness to bursty CLI compared to a bursty transmission which may interfere with UE transmission.

Furthermore, certain example embodiments having subband-based UE CLI measurements/reporting may provide enhanced possibilities for the network to benefit from frequency domain scheduling, for example, by avoiding scheduling UEs in subbands where they experience harmful UE-2-UE CLI conditions. In addition, in terms of CQI masking, certain example embodiments described herein impose no additional signaling overhead since CQI is already reported. As a further result, signalling overhead may be reduced, and reliability and latency improved. Thus, certain example embodiments are directed to improvements in computer-related technology.

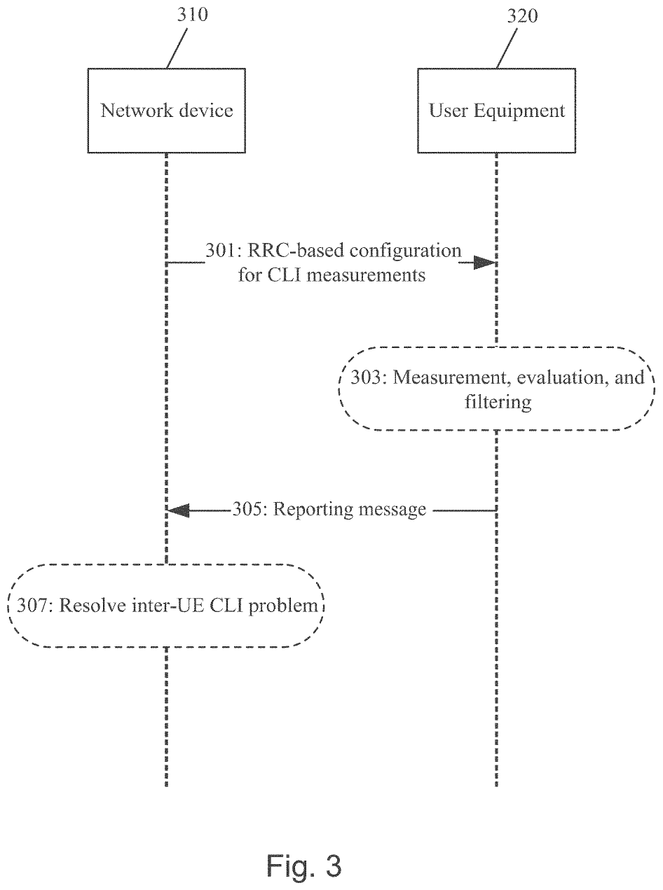

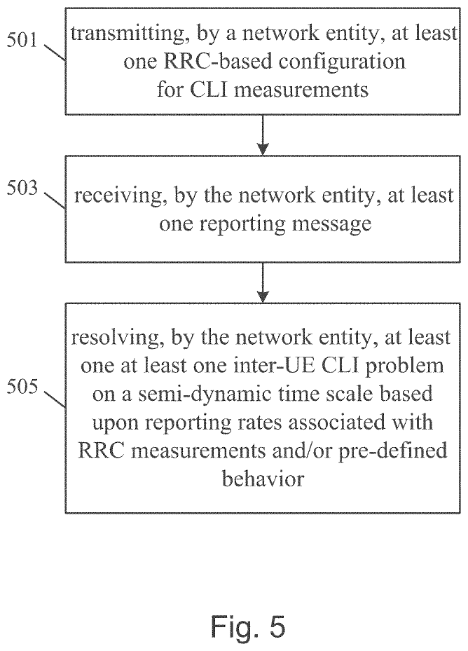

FIG. 3 illustrates a signaling diagram associated with RRC according to certain example embodiments. Network entity 310 may be similar to network entity 510 in FIG. 5, and user equipment 320 may be similar to user equipment 520 in FIG. 5. Although only a single user equipment (UE) and network entity (NE) are illustrated, a communications network may contain one or more of each of these entities. At 301, NE 310 may transmit at least one message to UE 320. In some example embodiments, the at least one message may include at least one CLI measurement framework object, such as CLImeasObject, which may be configured to add a new CLImeasObject, remove an existing CLImeasObject, and or modify an existing CLImeasObject. UE 320 may have zero, one, or more configured CLImeasObject parameters.

In certain example embodiments, the at least one CLI measurement framework object may be itemized as either received signal strength indicator (RSSI) or sounding reference signal-reference signal received power (SRS-RSRP). As an example, the corresponding SRS configuration that UE 310 may use for measuring SRS-RSRP may be included with SRS-RSRP.

In some example embodiments, the at least one CLI measurement framework object may include at least one L3 filtering parameter expressed as a filtering coefficient in an infinite impulse response (IIR) filter, or an equivalent time-domain averaging time.

In various example embodiments, the at least one CLI measurement framework object may include at least one reporting event condition, which may be periodic or event triggered. For example, for an event triggered reporting event condition, at least one UE CLI measurement may be reported when it exceeds a certain predefined threshold. Additionally or alternatively, at least one UE CLI measurement may be reported when the UE CLI measurement exceeds a certain level as compared to the UE measured RSRP from its serving cell, and/or UE experienced interference. In some example embodiments, the value of the at least one threshold may be part of the at least one measurement framework object, such as CLImeasObject. If the reporting is a function of the UE experienced interference, the measurement framework object may include information on whether the interference is based on simple RSSI and/or UE L1 interference measurements based on, for example, at least one CSI interference measurement (CSI-IM) resource and/or non-zero power (NZP) CSI-RS resource for interference measurements.

In certain example embodiments, the at least one CLI measurement framework object may be at least one reporting type. For example, the at least one CLI measurement framework object may be a CLI alert message, which may only indicate that the triggering criteria has been fulfilled. Additionally or alternatively, the at least one CLI measurement framework object may include at least one actual measured value of the UE CLI measurement, which may be expressed in dBm, as well as other potential measurements, such as the serving cell RSRP of the UE.

In some example embodiments, the at least one CLI measurement framework object may be associated with RRC signaling according to 3GPP TS 38.331 (RRC signaling). For example, RRC signaling may define at least one PHY/MAC procedure for CLI reporting. Such information may define whether the UE shall use implicit or explicit signaling of UE CLI measurements/information back to the network, as well as whether UE CLI measurements should be wideband or per subband.

In various example embodiments, the at least one CLI measurement framework object may be associated with PHY level reporting of UE CLI, as described in 3GPP TS 38.213. For example, the at least one CLI measurement framework object may include criteria defining when the UE CLI measurement relative to the UE interference measurement becomes larger than a predefined threshold. Furthermore, the UE may adopt implicit signalling of UE CLI measurements by configuring CQI reporting to “void” or “zero” if the measured CLI above at least one predefined threshold. In certain example embodiments, UE CLI reporting may be included with MAC-CE may be performed.

At 303, in response to receiving the at least one RRC-based CLI measurement framework object, UE 320 may determine whether fulfilment of the triggering criteria of the at least one received UE CLI measurement object has occurred. At 305, UE 320 may transmit at least one UE CLI measurement to NE 310, for example, as part of at least one RRC message, such as a CLI alert message. In some example embodiments, the at least one UE CLI measurement may indicate that the triggering criteria has been fulfilled, the actual measured value of the UE CLI measurement (e.g. expressed in dBm), the serving cell RSRP of the UE, and/or other potential measurements.

At 307, in response to receiving and analysing the at least one UE CLI measurement, NE 310 may take at least one action. For example, NE 310 may take at least one action to resolve inter-UE CLI problems on a semi-dynamic time scale based upon the reporting rates on RRC measurements and/or the desirable behavior. RRC messages may be sent only at a moderate rate, for example, every 20-100 ms.

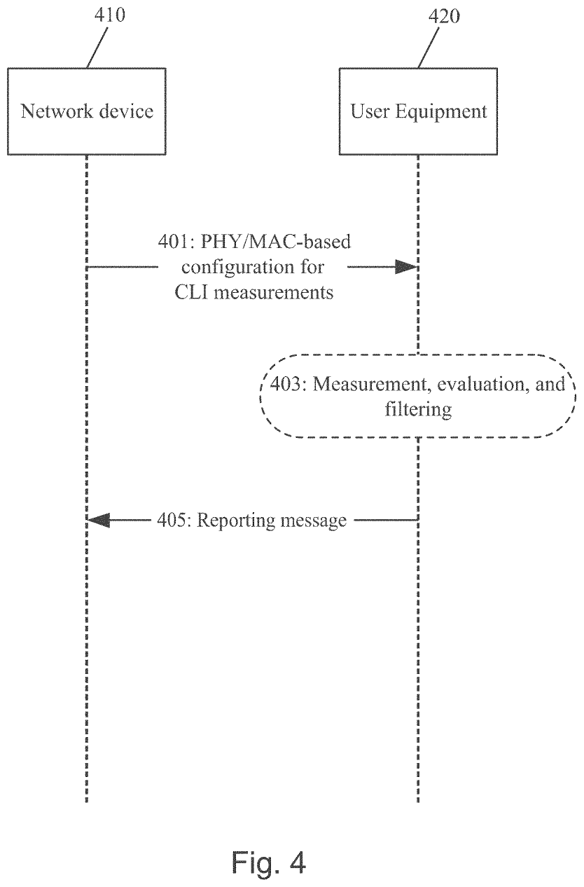

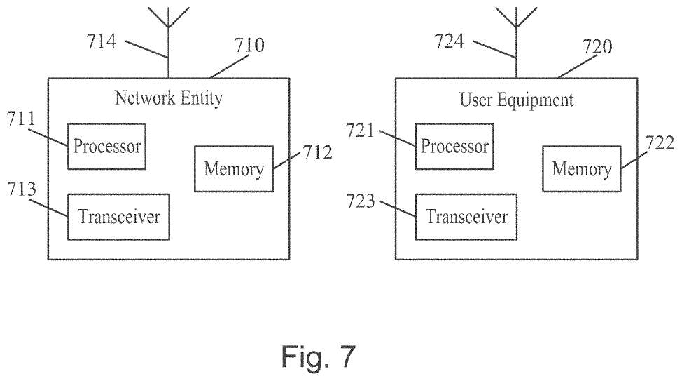

FIG. 4 illustrates a signaling diagram associated with PHY/MAC according to certain example embodiments. Network entity 410 may be similar to network entity 710 in FIG. 7, and user equipment 420 may be similar to user equipment 720 in FIG. 7. Although only a single user equipment (UE) and network entity (NE) are illustrated, a communications network may contain one or more of each of these entities. At 401, NE 410 may transmit at least one message to UE 420. In some example embodiments, the at least one message may configure UE 420 to measure CLI (such as RSSI or SRS-RSRP) and/or UE interference measurements, such as those based on CSI-IM resource or NZP CSI-RS resources for interference measurement. For example, such measurements may be configured to be wideband or frequency selective, such as per sub-band.

At 403, UE 420 may determine that at least one UE CLI measurement, such as SRS-RSRP, relative to at least one UE interference measurement becomes larger than at least one network-configured threshold. As a result, UE 420 may determine that at least one CLI problem exists.

At 405, UE 420 may transmit at least one message to NE 410 with at least one indication of the at least one detected CLI problem. For example, the at least one indication may be a Boolean indication, such as one included in at least one CLI alert message, and/or may be sent as a fast physical layer message (e.g. on PUCCH or PUSCH) or as a MAC-CE.

In some example embodiments, if at least one UE CLI and/or UE interference measurement is configured to be measured per subband, the at least one CLI alert message may be expressed as at least one vector of Boolean values, where each element may correspond to at least one of the subbands.

In various example embodiments, UE 420 may adopt implicit signaling of at least one UE CLI measurement, for example, by setting at least one CQI reporting parameter to “void” or “zero” if a CLI is measured above at least one predetermined threshold. Furthermore, at least one implicit signal of the at least one CLI alert message may be dependent on whether the CSI/CQI is configured to be wideband or per sub-band. As a result, this would not require additional signaling overhead while still transmitting information to NE 410 regarding when UE should not be scheduled when subject to CLI levels exceeding at least one predefined threshold. For example, NE 410 may not schedule UE when associated with “void” or “zero” CQI values.

In certain example embodiments, upon UE 420 informing NE 410 regarding CLI, NE 410 may allocate UL resources so that UE 420 may transmit a detailed CLI measurement report, such as a PHY/MAC/RRC hybrid.

FIG. 5 illustrates an example of a method performed by a NE, for example, NE 710 in FIG. 7. At 501, the network entity may transmit at least one message to a user equipment. In some example embodiments, the at least one message may include at least one CLI measurement framework object, such as CLImeasObject, which may be configured to add a new CLImeasObject, remove an existing CLImeasObject, and or modify an existing CLImeasObject. The user equipment may have zero, one, or more configured CLImeasObject parameters.

In certain example embodiments, the at least one CLI measurement framework object may be itemized as either received signal strength indicator (RSSI) or sounding reference signal-reference signal received power (SRS-RSRP). As an example, the corresponding SRS configuration that the user equipment may use for measuring SRS-RSRP may be included with SRS-RSRP.

In some example embodiments, the at least one CLI measurement framework object may include at least one L3 filtering parameter expressed as a filtering coefficient in an infinite impulse response (IIR) filter, or an equivalent time-domain averaging time.

In various example embodiments, the at least one CLI measurement framework object may include at least one reporting event condition, which may be periodic or event triggered. For example, for an event triggered reporting event condition, at least one UE CLI measurement may be reported when it exceeds a certain predefined threshold. Additionally or alternatively, at least one UE CLI measurement may be reported when the UE CLI measurement exceeds a certain level as compared to the UE measured RSRP from its serving cell, and/or UE experienced interference. In some example embodiments, the value of the at least one threshold may be part of the at least one measurement framework object, such as CLImeasObject. If the reporting is a function of the UE experienced interference, the measurement framework object may include information on whether the interference is based on simple RSSI and/or UE L1 interference measurements based on, for example, at least one CSI interference measurement (CSI-IM) resource and/or non-zero power (NZP) CSI-RS resource for interference measurements.

In certain example embodiments, the at least one CLI measurement framework object may be at least one reporting type. For example, the at least one CLI measurement framework object may be a CLI alert message, which may only indicate that the triggering criteria has been fulfilled. Additionally or alternatively, the at least one CLI measurement framework object may include at least one actual measured value of the UE CLI measurement, which may be expressed in dBm, as well as other potential measurements, such as the serving cell RSRP of the UE.

In some example embodiments, the at least one CLI measurement framework object may be associated with RRC signaling according to 3GPP TS 38.331 (RRC signaling). For example, RRC signaling may define at least one PHY/MAC procedure for CLI reporting. Such information may define whether the UE shall use implicit or explicit signaling of UE CLI measurements/information back to the network, as well as whether UE CLI measurements should be wideband or per subband.

In various example embodiments, the at least one CLI measurement framework object may be associated with PHY level reporting of UE CLI, as described in 3GPP TS 38.213 (CLI Alert Message). For example, the at least one CLI measurement framework object may include criteria defining when the UE CLI measurement relative to the UE interference measurement becomes larger than a predefined threshold. Furthermore, the UE may adopt implicit signalling of UE CLI measurements by configuring CQI reporting to “void” or “zero” if a CLI above at least one predefined threshold is measured. In addition, UE CLI reporting associated with MAC-CE may be performed as described in 3GPP TS 38.324.

At 503, the network entity may receive at least one UE CLI measurement, for example, as part of at least one RRC message, such as a CLI alert message. In some example embodiments, the at least one UE CLI measurement may indicate that the triggering criteria has been fulfilled, the actual measured value of the UE CLI measurement (e.g. expressed in dBm), the serving cell RSRP of the UE, and/or other potential measurements.

At 505, in response to receiving the at least one reporting message, the network entity may take at least one action. For example, the network entity may take at least one action to resolve at least one inter-UE CLI problem on a semi-dynamic time scale based upon at least one reporting rate associated with RRC measurements and/or the desirable behavior. RRC messages may be sent only at a moderate rate, for example, every 20-100 ms.

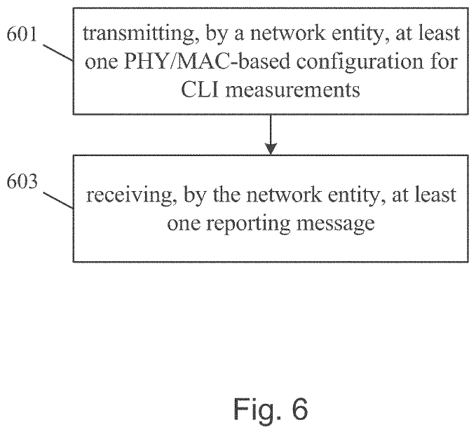

FIG. 6 illustrates an example of a method performed by a NE, for example, NE 710 in FIG. 7. At 601, the network entity may transmit at least one message to a user equipment. In some example embodiments, the at least one message may configure the user equipment to measure CLI (such as RSSI or SRS-RSRP) and/or UE interference measurements, such as those based on CSI-IM resource or NZP CSI-RS resources for interference measurement. For example, such measurements may be configured to be wideband or frequency selective, such as per sub-band.

At 603, the network entity may receive at least one message from the user equipment with at least one indication of the at least one detected CLI problem. For example, the at least one indication may be a Boolean indication, such as one included in at least one CLI alert message, and/or may be sent as a fast physical layer message (e.g. on PUCCH or PUSCH) or as a MAC-CE.

In some example embodiments, if at least one UE CLI and/or UE interference measurement is configured to be measured per subband, the at least one CLI alert message may be expressed as at least one vector of Boolean values, where each element may correspond to at least one of the subbands.

In certain example embodiments, upon the user equipment informing the network entity regarding CLI, the network entity may allocate UL resources so that the user equipment may transmit a detailed CLI measurement report, such as a PHY/MAC/RRC hybrid.

FIG. 7 illustrates an example of a system according to certain example embodiments. In one example embodiment, a system may include multiple devices, such as, for example, network entity 710 and/or user equipment 720.

Network entity 710 may be one or more of a base station, such as an evolved node B (eNB) or 5G or New Radio node B (gNB), a serving gateway, a server, and/or any other access node or combination thereof. Furthermore, network entity 710 and/or user equipment 720 may be one or more of a citizens broadband radio service device (CBSD).

User equipment 720 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

One or more of these devices may include at least one processor, respectively indicated as 711 and 721. Processors 711 and 721 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of devices indicated at 712 and 722. The memory may be fixed or removable. The memory may include computer program instructions or computer code contained therein. Memories 712 and 722 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory and which may be processed by the processors may be any suitable form of computer program code, for example, a compiled or interpreted computer program written in any suitable programming language. Memory may be removable or non-removable.

Processors 711 and 721 and memories 712 and 722 or a subset thereof, may be configured to provide means corresponding to the various blocks of FIGS. 3-6. Although not shown, the devices may also include positioning hardware, such as GPS or micro electrical mechanical system (MEMS) hardware, which may be used to determine a location of the device. Other sensors are also permitted and may be included to determine location, elevation, orientation, and so forth, such as barometers, compasses, and the like.

As shown in FIG. 7, transceivers 713 and 723 may be provided, and one or more devices may also include at least one antenna, respectively illustrated as 714 and 724. The device may have many antennas, such as an array of antennas configured for multiple input multiple output (MIMO) communications, or multiple antennas for multiple radio access technologies. Other configurations of these devices, for example, may be provided. Transceivers 713 and 723 may be a transmitter, a receiver, or both a transmitter and a receiver, or a unit or device that may be configured both for transmission and reception.

The memory and the computer program instructions may be configured, with the processor for the particular device, to cause a hardware apparatus such as user equipment to perform any of the processes described below (see, for example, FIGS. 3-6). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-6. For example, circuitry may be hardware-only circuit implementations, such as analog and/or digital circuitry. In another example, circuitry may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

The features, structures, or characteristics of certain example embodiments described throughout this specification may be combined in any suitable manner in one or more example embodiments. For example, the usage of the phrases “certain example embodiments,” “some example embodiments,” “other example embodiments,” or other similar language, throughout this specification refers to the fact that a particular feature, structure, or characteristic described in connection with the example embodiment may be included in at least one example embodiment of the present invention. Thus, appearance of the phrases “in certain example embodiments,” “in some example embodiments,” “in other example embodiments,” or other similar language, throughout this specification does not necessarily refer to the same group of example embodiments, and the described features, structures, or characteristics may be combined in any suitable manner in one or more example embodiments.

One having ordinary skill in the art will readily understand that certain example embodiments discussed above may be practiced with steps in a different order, and/or with hardware elements in configurations which are different than those which are disclosed. Therefore, it would be apparent to those of skill in the art that certain modifications, variations, and alternative constructions would be apparent, while remaining within the spirit and scope of the invention. In order to determine the metes and bounds of the invention, therefore, reference should be made to the appended claim-link paragraphs.

### Partial Glossary

3GPP 3rd Generation Partnership Project

BW Bandwidth

BWP Bandwidth Part

CLI Cross Link Interference

CQI Channel Quality Indication

C-RNTI Cell radio Network Temporary Identifier

CSI-RS Channel State Information-Reference Signal

DCI Downlink Control Information

DL Downlink

DMRS Demodulation Reference Signal

DRB Data Radio Bearer

DRX Discontinuous Reception

eMBB Enhanced Mobile Broadband

eNB Evolved Node B

EPC Evolved Packet Core

gNB Next Generation eNB

GPS Global Positioning System

LTE Long-Term Evolution

MAC Medium Access Control

MAC-CE Medium Access Control Control Element

MME Mobility Management Entity

MSP Measurement Profile

MTC Machine-Type Communications

NE Network Entity

NR New Radio

NZP Non-Zero-Power

PDCCH Physical Downlink Control Channel

PUCCH Physical Uplink Control Channel

PDCP Packet Data Convergence Protocol

PDSCH Physical Downlink Shared Channel

PUSCH Physical Uplink Shared Channel

PHY Physical Layer

RAN Radio Access Network

RLC Radio Link Control

RRC Radio Resource Control

RRM Radio Resource Management

RSRP Reference Signal Received Power

RSSI Received Signal Strength Indicator

SDAP Service Data Adaptation Protocol

SMTC SS Block-Based RRM Measurement Timing Configuration

SRS Sounding Reference Signal

SSB Synchronization Signal Block/Physical Broadcast Channel

UE User Equipment

UL Uplink

WLAN Wireless Local Area Network

1. A method, comprising:
transmitting, by a network entity, at least one radio resource control (RRC)-based cross link interference (CLI) measurement framework object configured for at least one user equipment (UE) CLI measurement;
receiving, by the network entity, at least one reporting message; and
resolving, by the network entity, at least one inter-UE CLI problem on a semi-dynamic time scale based upon reporting rates associated with RRC measurements and/or pre-defined behavior.

2. The method according to claim 1, wherein the at least one CLI measurement framework object is configured to one or more of add at least one new CLImeasObject, remove at least one existing CLImeasObject, and modify at least one existing CLImeasObject.

3. The method according to claim 1, wherein the at least one CLI measurement framework object is itemized as either received signal strength indicator (RSSI) or sounding reference signal-reference signal received power (SRS-RSRP).

4. The method according to claim 1, wherein the at least one CLI measurement framework object comprises at least one L3 filtering parameter expressed as a filtering coefficient in an infinite impulse response (IIR) filter, or an equivalent time-domain averaging time.

5. The method according to claim 1, wherein the at least one CLI measurement framework object comprises at least one reporting event condition.

6.-30. (canceled)

31. An apparatus, comprising:
at least one processor; and
at least one memory including computer program code,
the at least one memory and the computer program code configured to, with the at least one processor, cause the apparatus at least to:
transmit at least one radio resource control (RRC)-based cross link interference (CLI) measurement framework object configured for at least one user equipment (UE) CLI measurement;
receive at least one reporting message; and
resolve at least one inter-UE CLI problem on a semi-dynamic time scale based upon reporting rates associated with RRC measurements and/or pre-defined behavior.

32. The apparatus according to claim 31, wherein the at least one CLI measurement framework object is configured to one or more of add at least one new CLImeasObject, remove at least one existing CLImeasObject, and modify at least one existing CLImeasObject.

33. The apparatus according to claim 31, wherein the at least one CLI measurement framework object is itemized as either received signal strength indicator (RSSI) or sounding reference signal-reference signal received power (SRS-RSRP).

34. The apparatus according to claim 31, wherein the at least one CLI measurement framework object comprises at least one L3 filtering parameter expressed as a filtering coefficient in an infinite impulse response (IIR) filter, or an equivalent time-domain averaging time.

35. The apparatus according to claim 31, wherein the at least one CLI measurement framework object comprises at least one reporting event condition.

36. An apparatus, comprising:
at least one processor; and
at least one memory including computer program code,
the at least one memory and the computer program code configured to, with the at least one processor, cause the apparatus at least to:
transmit at least one physical layer (PHY)/medium access control (MAC)-based configuration for at least one cross link interference (CLI) measurement; and
receive at least one reporting message.

37. The apparatus according to claim 36, wherein the at least one CLI measurement framework object is configured to one or more of add at least one new CLImeasObject, remove at least one existing CLImeasObject, and modify at least one existing CLImeasObject.

38. The apparatus according to claim 36, wherein the at least one CLI measurement framework object is itemized as either received signal strength indicator (RSSI) or sounding reference signal-reference signal received power (SRS-RSRP).

39. The apparatus according to claim 36, wherein the at least one CLI measurement framework object comprises at least one L3 filtering parameter expressed as a filtering coefficient in an infinite impulse response (IIR) filter, or an equivalent time-domain averaging time.

40. The apparatus according to claim 36, wherein the at least one CLI measurement framework object comprises at least one reporting event condition.

41.-44. (canceled)
